(19) United States
(12) Patent Application Publication
(10) Pub. No.: US 2025/0203488 A1
(43) Pub. Date: Jun. 19, 2025

(54) USER EQUIPMENT AND NETWORK BEHAVIOR WITH RESTRICTED SATELLITE ACCESS BY SUBSCRIPTION IN MOBILE COMMUNICATIONS

(71) Applicant: MediaTek Singapore Pte. Ltd., Singapore (SG)

(72) Inventors: Marko NIEMI, Oulu (FI); Yuan-Chieh LIN, Hsinchu City (TW)

(21) Appl. No.: 18/844,932

(22) PCT Filed: Mar. 27, 2023
(86) PCT No.: PCT/CN2023/084058

§ 371 Date: Sep. 6, 2024

Related U.S. Application Data
(60) Provisional application No. 63/333,581, filed on Apr. 22, 2022.

(51) Int. Cl. H04W 48/02; H04W 8/18; H04W 60/06; H04W 84/04; H04W 84/06

(52) U.S. Cl. CPC H04W 48/02; H04W 8/183; H04W 60/06; H04W 84/042; H04W 84/06

(57) ABSTRACT

Examples pertaining to user equipment (UE) and network behavior with restricted satellite access by subscription in mobile communications are described. A user equipment (UE) receives from a satellite access cell of a network a message with a reject cause. The UE then either or both refrains to attempt the satellite access and disables the satellite access capability of the UE responsive to receiving the message.

### CROSS REFERENCE TO RELATED PATENT APPLICATION(S)

The present disclosure is part of a non-provisional application claiming the priority benefit of U.S. Patent Application No. 63/333,581, filed 22 Apr. 2022, the content of which herein being incorporated by reference in its entirety.

### TECHNICAL FIELD

The present disclosure is generally related to mobile communications and, more particularly, to user equipment (UE) and network behavior with restricted satellite access by subscription in mobile communications.

### BACKGROUND

Unless otherwise indicated herein, approaches described in this section are not prior art to the claims listed below and are not admitted as prior art by inclusion in this section.

In wireless communications such as mobile communications in accordance with the 3^{rd} Generation Partnership Project (3GPP) Technical Specification (TS) 23.501 subsection 5.3.4.1.1, a UE may have a radio access technology (RAT) restriction for a public land mobile network (PLMN) based on subscription (e.g., non-terrestrial versus terrestrial). In a CONNECTED state, the network would ensure that the UE is not handed over to a forbidden RAT. The RAT restriction is enforced in the network and is not provided to the UE. In order to enforce all primary or secondary access restrictions, a related access has to be deployed in different Tracking Area Codes (TACs) and the subscriber (e.g., UE) would not be allowed to access the network in tracking areas (Tas) using the particular access.

However, there is an issue that cannot be addressed by aforementioned mechanisms when a Universal Subscriber Identity Module (USIM) with a satellite-restricted subscription is inserted in a UE that supports satellite access. More specifically, although by the aforementioned mechanisms the network could restrict handovers of the UE to forbidden RATs and forbidden TAs, while in an IDLE mode the UE could continue attempting service over and over again in TAs that are not yet forbidden, thereby causing unnecessary signaling load to the network as well as power consumption (e.g., draining out battery power of the UE), which would be extremely undesirable for an Internet-of-Things (IoT) device as the UE. Moreover, none of the aforementioned mechanisms are efficient in a case in which the UE by its subscription is not allowed to use satellite access in a PLMN, multiple PLMNs or all PLMNs. Furthermore, none of the aforementioned mechanisms could inform the UE that an access type (e.g., satellite access) itself is restricted by subscription and, thus, the UE should rather attempt service over another supported RAT. Therefore, there is a need for a solution of UE and network behavior with restricted satellite access by subscription in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to UE and network behavior with restricted satellite access by subscription in mobile communications. It is believed that the above-described issue would be avoided or otherwise alleviated by implementing one or more of the proposed schemes described herein.

In one aspect, a method may involve a processor of an apparatus (e.g., UE) receiving from a satellite access cell of a network a message with a reject cause. The method may also involve the processor either or both refraining to attempt a satellite access and disabling the satellite access capability of the UE responsive to receiving the message.

In another aspect, a method may involve processor of a user equipment (UE) determining satellite access by the UE is allowed according to a UE configuration. The method may also involve the processor implementing a result of the determining. The UE configuration may include a USIM configuration or a management object (MO) configuration.

In yet another aspect, an apparatus may include a transceiver and a processor coupled to the transceiver. The transceiver may be configured to communicate wirelessly. The processor may receive, via the transceiver, from a satellite access cell of a network a message with a reject cause. The processor may also either or both refrain to attempt a satellite access and disable the satellite access capability of the UE responsive to receiving the message.

It is noteworthy that, although description provided herein may be in the context of certain radio access technologies, networks and network topologies such as 5G New Radio (NR) and 4G Evolved Packet System (EPS) mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

FIG. 4 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UE and network behavior with restricted satellite access by subscription in mobile communications. According to the present disclosure, a number of possible solutions may be implemented separately or jointly. That is, although these possible solutions may be described below separately, two or more of these possible solutions may be implemented in one combination or another.

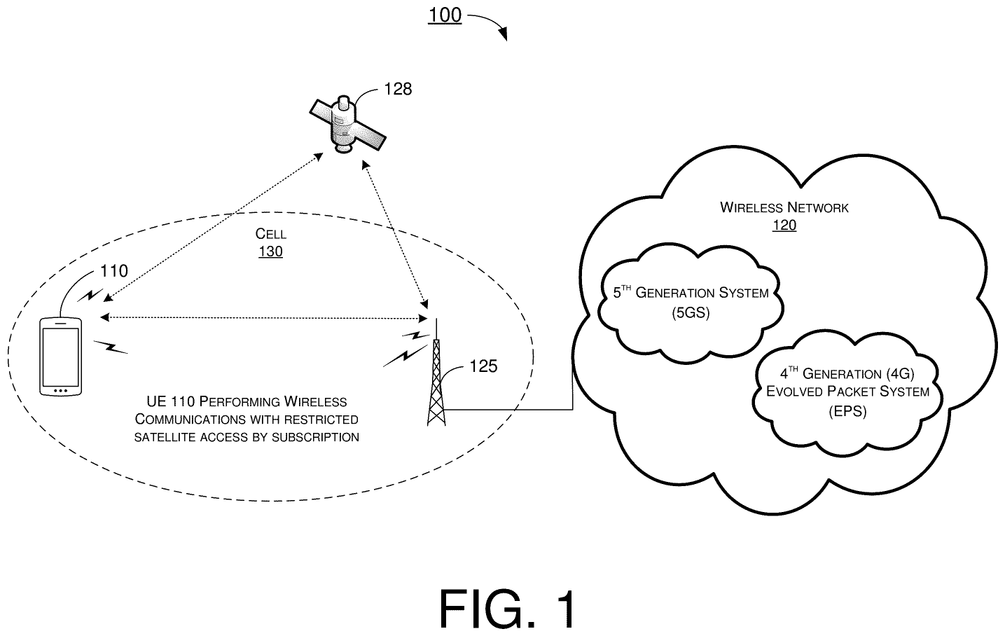

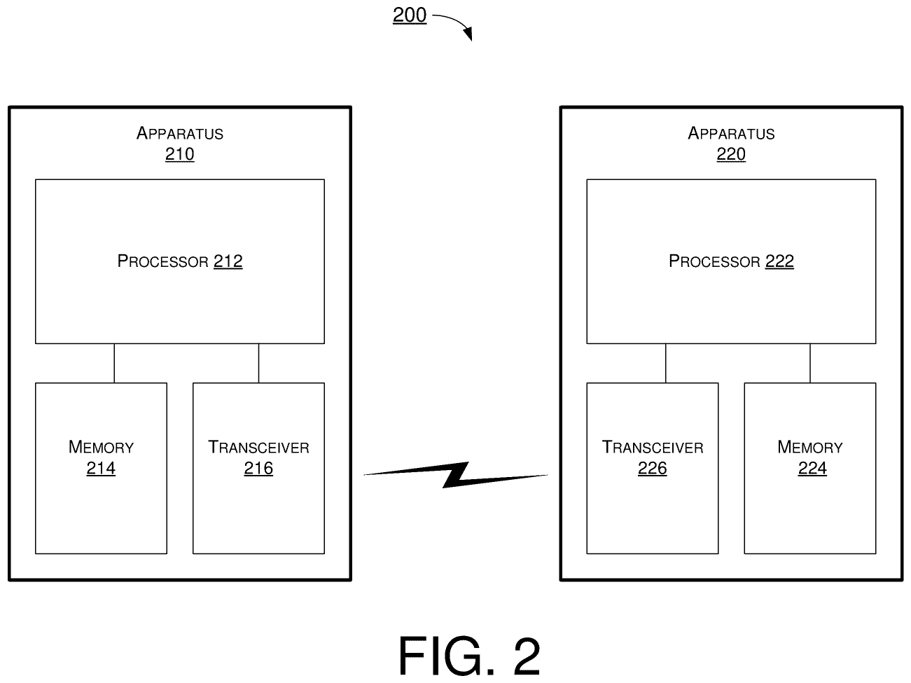

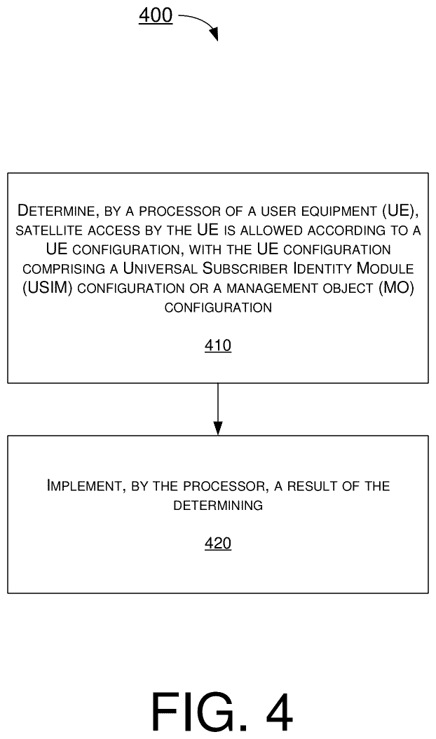

FIG. 1 illustrates an example network environment 100 in which various solutions and schemes in accordance with the present disclosure may be implemented. FIG. 2˜FIG. 4 illustrate examples of implementation of various proposed schemes in network environment 100 in accordance with the present disclosure. The following description of various proposed schemes is provided with reference to FIG. 1˜FIG. 4.

Referring to FIG. 1, network environment 100 may involve a UE 110 and a wireless network 120, which may include a 5GS, a 4G EPS, a 3G network and a 2G network. Depending on channel condition, availability and/or other factor(s), UE 110 may be in wireless communication with wireless network 120 via one or more terrestrial network nodes (e.g., base station(s) such as eNB, gNB and/or transmission/reception point (TRP)) and/or one or more non-terrestrial network nodes (e.g., satellite(s)). For simplicity in illustration and without limiting the scope of the present disclosure, UE 110 may be associated with or otherwise in communication with a cell 130 corresponding to a terrestrial network node 125 (e.g., gNB, eNB or TRP) and/or a non-terrestrial network node 128 (e.g., satellite) of wireless network 120. In network environment 100, UE 110 and wireless network 120 may implement various schemes pertaining to UE and network behavior with restricted satellite access by subscription in mobile communications in accordance with the present disclosure, as described below. It is noteworthy that, while the various proposed schemes may be individually or separately described below, in actual implementations each of the proposed schemes may be utilized individually or separately. Alternatively, some or all of the proposed schemes may be utilized jointly. In any case, implementation of one or more of the proposed schemes does not exclude implementation of one or more other alternative proposed schemes.

Under various proposed schemes in accordance with the present disclosure, in an event that wireless network 120 detects that UE 110 should stop attempting satellite access due to subscription-based restriction(s), a new indication (e.g., a reject cause in a REJECT message) may be sent to UE 110 to inform UE 110 that one or more satellite access(es) are restricted by subscription in one or more PLMNs. Each of the following proposed schemes pertains to a respective type of new reject cause(s) and functionality as a response to a registration request, an attach request, a tracking area update (TAU) request or a service request (SR) from UE 110.

Under a first proposed scheme in accordance with the present disclosure, in an event that wireless network 120 detects that UE 110 should stop attempting satellite access due to subscription-based restriction(s), wireless network 120 may transmit (e.g., via terrestrial network node 125 or non-terrestrial network node 128) to UE 110 a reject cause #xy indicating that satellite access is not allowed. Upon receipt of such indication, UE 110 may disable its satellite access capability for at least one of the following: (i) a specific access for which the message was received; (ii) an access to all satellites; and/or (iii) a specific public land mobile network (PLMN) for which the message was received or all PLMNs until: (a) UE 110 being switched off and back on; or (b) a different USIM being inserted into UE 110; or (c) expiry of a timer.

Under a second proposed scheme in accordance with the present disclosure, in an event that wireless network 120 detects that UE 110 should stop attempting satellite access due to subcription-based restriction(s), wireless network 120 may transmit (e.g., via terrestrial network node 125 or non-terrestrial network node 128) to UE 110 a reject cause #xx indicating that satellite access XX is not allowed (e.g., pertaining to a certain type of satellite access). Upon receipt of such indication, UE 110 may disable the specific satellite access by UE 110 for a specific PLMN for which the message was received or all PLMNs until: (a) UE 110 being switched off and back on; or (b) a different USIM being inserted into UE 110; or (c) expiry of a timer.

Under a third proposed scheme in accordance with the present disclosure, in an event that wireless network 120 detects that UE 110 should stop attempting satellite access due to subcription-based restriction(s), wireless network 120 may transmit (e.g., via terrestrial network node 125 or non-terrestrial network node 128) to UE 110 a reject cause #xz indicating that satellite access XX is not allowed in a particular PLMN. Upon receipt of such indication, UE 110 may disable the specific satellite access by UE 110 for the specific PLMN for which the message was received. Moreover, processor 212 may also enable the satellite access capability of UE 110 upon expiry of a related timer.

Under a fourth proposed scheme in accordance with the present disclosure, in an event that wireless network 120 determines that a UE subscription has changed while UE 110 is registered in wireless network 120 and in an IDLE mode or a CONNECTED mode, wireless network 120 may notify, de-register or detach UE 110 from wireless network 120 by indicating that satellite access xyz is not allowed in zyx. For instance, wireless network 120 may transmit (e.g., via terrestrial network node 125 or non-terrestrial network node 128) to UE 110 a DEREGISTRATION message or a DETACH message with the reject cause indicating that satellite access xyz is not allowed in zyx.

Under a fifth proposed scheme in accordance with the present disclosure, UE 110 may be restricted or allowed to use satellite access by UE configuration. For instance, a USIM configuration allowing or restricting the use of satellite access may be configured with a satellite restricted subscription, and a USIM storing such USIM configuration may be inserted into UE 110. The USIM configuration may be configured with, for example, service #xyz “allowed to access satellites” and/or service #xyz “restricted access to satellites.” Under the proposed scheme, there may be an optional elementary file (EF) that describes the allowance or restriction in more detail. Optionally, it may be specified that a lack or non-existence of a satellite access as RAT in an Operator Controlled PLMN Selector with Access Technology list, which may be interpreted to mean that UE 110 is not allowed to use satellite access (e.g., next-generation RAN (NG-RAN) or Evolved Universal Mobile Telecommunications System (UMTS) Radio Access Network (E-UTRAN) or both) either in mentioned PLMN(s) or in any PLMNs. Under the proposed scheme, a management object (MO) configuration (e.g., a non-access stratum (NAS) configuration MO) allowing or not allowing the use of satellite access in mentioned PLMN(s) or any PLMN may be utilized in the UE configuration.

It is noteworthy that, with respect to a timer in above-described first, second, third and fourth proposed schemes, UE 110 may have a specific timer started from reception of the reject (e.g., reject cause) and, at expiry of the timer, UE 110 may be allowed to start using the satellite access again. The timer may be stopped when a new USIM is inserted into UE 110 and/or may be stopped when UE 110 is switched OFF and ON again.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to UE and network behavior with restricted satellite access by subscription in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to UE and network behavior with restricted satellite access by subscription in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 214 and memory 224 may include a UICC.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., terrestrial network node 125 or non-terrestrial network node 128) of a wireless network (e.g., wireless network 120), is provided below.

Under certain proposed schemes in accordance with the present disclosure with respect to UE and network behavior with restricted satellite access by subscription in mobile communications, processor 212 of apparatus 210, implemented in or as UE 110, may receive, via transceiver 216, from a satellite access cell of a network (e.g., from wireless network 120 via apparatus 220) a message with a reject cause. Additionally, processor 212 may either or both refrain to attempt a satellite access and disable the satellite access capability of apparatus 210 responsive to receiving the message.

In some implementations, the reject cause may indicate that the satellite access is not allowed. In such cases, in either or both refraining to attempt the satellite access and disabling the satellite access capability of apparatus 210, processor 212 may refrain to attempt the satellite access and disable the satellite access capability of apparatus 210 for one or more of the following: (i) a specific access for which the message was received; (ii) an access to all satellites; (iii) a specific PLMN for which the message was received or all PLMNs until: (a) apparatus 210 being switched off and back on; or (b) a different USIM being inserted into apparatus 210; or (c) expiry of a timer.

In some implementations, the reject cause may indicate that attempting a specific satellite access is not allowed. In such cases, in either or both refraining to attempt the satellite access and disabling the satellite access capability of apparatus 210, processor 212 may refrain to attempt the specific satellite access and disable the specific satellite access by apparatus 210 for a specific PLMN for which the message was received or all PLMNs until: (a) apparatus 210 being switched off and back on; or (b) a different USIM being inserted into apparatus 210; or (c) expiry of a timer.

In some implementations, the reject cause may indicate that re-attempting a specific satellite access is not allowed for a specific PLMN. In such cases, in disabling the satellite access capability of apparatus 210, processor 212 may disable the specific satellite access by apparatus 210 for the specific PLMN for which the message was received. Moreover, processor 212 may also enable the satellite access capability of apparatus 210 upon expiry of a related timer.

In some implementations, the message may include a reject message, a DEREGISTRATION message or a DETACH message with the reject cause. In such cases, in receiving the message, processor 212 may receive the message upon the network determining that a UE subscription has changed while apparatus 210 is registered in the network and in an IDLE mode or a CONNECTED mode.

In some implementations, processor 212 may further utilize a USIM responsive to the USIM being inserted into apparatus 210. The USIM may be configured with a satellite restricted subscription. In such cases, in receiving the message with the reject cause, processor 212 may receive the message from the network responsive to utilizing the USIM.

In some implementations, processor 212 may either or both allow to access the satellite access and enable the satellite access capability of apparatus 210 responsive to: (i) apparatus 210 being switched off and back on; or (b) a different USIM being inserted into apparatus 210; or (c) expiry of a timer.

In some implementations, processor 212 may perform additional operations. For instance, processor 212 may start a timer responsive to receiving the message with the reject cause. Moreover, processor 212 may enable the satellite access capability of apparatus 210 responsive to expiry of the timer. The timer may be stopped responsive to either apparatus 210 being switched off and back on or a different USIM being inserted into apparatus 210.

Under other proposed schemes in accordance with the present disclosure with respect to UE and network behavior with restricted satellite access by subscription in mobile communications, processor 212 of apparatus 210, implemented in or as UE 110, may determine that satellite access by apparatus 210 is allowed according to a UE configuration. The UE configuration may include a USIM configuration or a MO configuration. Furthermore, processor 212 may implement, via transceiver 216, a result of the determining.

In some implementations, the USIM configuration may indicate one or more of the following: (i) the satellite access to a specific service being allowed or restricted; (ii) description of allowance of the satellite access or a restriction on the satellite access; and (iii) an Operator Controlled PLMN Selector with Access Technology list not containing the satellite access as a RAT in one or more PLMNs.

In some implementations, the MO configuration may include a NAS configuration MO indicating allowance or a restriction on the satellite access in one or more PLMNs.

### Illustrative Processes

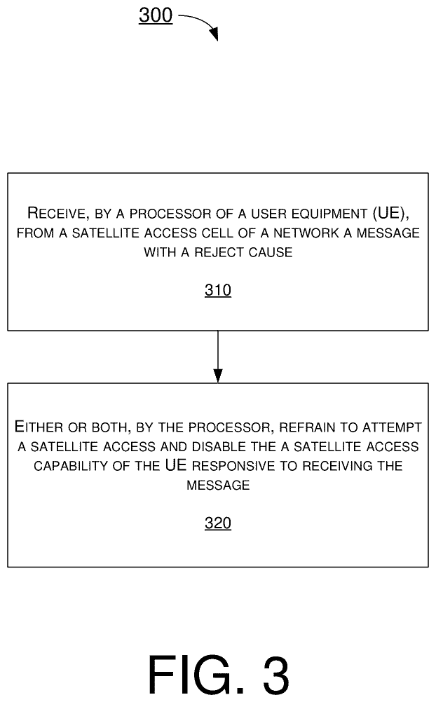

FIG. 3 illustrates an example process 300 in accordance with an implementation of the present disclosure. Process 300 may represent an aspect of implementing various proposed designs, concepts, schemes, systems and methods described above, whether partially or entirely, including those described above. More specifically, process 300 may represent an aspect of the proposed concepts and schemes pertaining to UE and network behavior with restricted satellite access by subscription in mobile communications. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., terrestrial network node 125 or non-terrestrial network node 128) of a network (e.g., wireless network 120). Process 300 may begin at block 310.

At 310, process 300 may involve processor 212 of apparatus 210, implemented in or as UE 110 receiving, via transceiver 216, from a satellite access cell of a network (e.g., from wireless network 120 via apparatus 220) a message with a reject cause. Process 300 may proceed from 310 to 320.

At 320, process 300 may involve processor 212 either or both refraining to attempt a satellite access and disabling the satellite access capability of apparatus 210 responsive to receiving the message.

In some implementations, the reject cause may indicate that the satellite access is not allowed. In such cases, in either or both refraining to attempt the satellite access and disabling the satellite access capability of apparatus 210, process 300 may involve processor 212 refraining to attempt the satellite access and disabling the satellite access capability of apparatus 210 for one or more of the following: (i) a specific access for which the message was received; (ii) an access to all satellites; and (iii) a specific PLMN for which the message was received or all PLMNs until: (a) apparatus 210 being switched off and back on; or (b) a different USIM being inserted into apparatus 210; or (c) expiry of a timer.

In some implementations, the reject cause may indicate that attempting a specific satellite access is not allowed. In such cases, in either or both refraining to attempt the satellite access and disabling the satellite access capability of apparatus 210, process 300 may involve processor 212 refraining to attempt the specific satellite access and disabling the specific satellite access by apparatus 210 for a specific PLMN for which the message was received or all PLMNs until: (a) apparatus 210 being switched off and back on; or (b) a different USIM being inserted into apparatus 210; or (c) expiry of a timer.

In some implementations, the reject cause may indicate that re-attempting a specific satellite access is not allowed for a specific PLMN. In such cases, in disabling the satellite access capability of apparatus 210, process 300 may involve processor 212 disabling the specific satellite access by apparatus 210 for the specific PLMN for which the message was received. Moreover, process 300 may further involve processor 212 enabling the satellite access capability of apparatus 210 upon expiry of a related timer.

In some implementations, the message may include a reject message, a DEREGISTRATION message or a DETACH message with the reject cause. In such cases, in receiving the message, process 300 may involve processor 212 receiving the message upon the network determining that a UE subscription has changed while apparatus 210 is registered in the network and in an IDLE mode or a CONNECTED mode.

In some implementations, process 300 may further involve processor 212 utilizing a USIM responsive to the USIM being inserted into apparatus 210. The USIM may be configured with a satellite restricted subscription. In such cases, in receiving the message with the reject cause, process 300 may involve processor 212 receiving the message from the network responsive to utilizing the USIM.

In some implementations, process 300 may further involve processor 212 either or both allowing to access the satellite access and enabling the satellite access capability of apparatus 210 responsive to: (i) apparatus 210 being switched off and back on; or (b) a different USIM being inserted into apparatus 210; or (c) expiry of a timer.

In some implementations, process 300 may further involve processor 212 performing additional operations. For instance, process 300 may involve processor 212 starting a timer responsive to receiving the message with the reject cause. Moreover, process 300 may involve processor 212 enabling the satellite access capability of apparatus 210 responsive to expiry of the timer. The timer may be stopped responsive to either apparatus 210 being switched off and back on or a different USIM being inserted into apparatus 210.

FIG. 4 illustrates an example process 400 in accordance with an implementation of the present disclosure. Process 400 may represent an aspect of implementing various proposed designs, concepts, schemes, systems and methods described above, whether partially or entirely, including those described above. More specifically, process 400 may represent an aspect of the proposed concepts and schemes pertaining to UE and network behavior with restricted satellite access by subscription in mobile communications. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., terrestrial network node 125 or non-terrestrial network node 128) of a network (e.g., wireless network 120). Process 400 may begin at block 410.

At 410, process 400 may involve processor 212 of apparatus 210, implemented in or as UE 110 determining that satellite access by apparatus 210 is allowed according to a UE configuration. The UE configuration may include a USIM configuration or a MO configuration. Process 400 may proceed from 410 to 420.

At 420, process 400 may involve processor 212 implementing, via transceiver 216, a result of the determining.

In some implementations, the USIM configuration may indicate one or more of the following: (i) the satellite access to a specific service being allowed or restricted; (ii) description of allowance of the satellite access or a restriction on the satellite access; and (iii) an Operator Controlled PLMN Selector with Access Technology list not containing the satellite access as a RAT in one or more PLMNs.

In some implementations, the MO configuration may include a NAS configuration MO indicating allowance or a restriction on the satellite access in one or more PLMNs.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), from a satellite access cell of a network a message with a reject cause; and
either or both, by the processor, refraining to attempt a satellite access and disabling the satellite access capability of the UE responsive to receiving the message.

2. The method of claim 1, wherein the reject cause indicates that the satellite access is not allowed, and wherein the either or both refraining to attempt the satellite access and disabling the satellite access capability of the UE comprises refraining to attempt the satellite access and disabling the satellite access capability of the UE for one or more of:
a specific access for which the message was received;
an access to all satellites; and
a specific public land mobile network (PLMN) for which the message was received or all PLMNs until:
the UE being switched off and back on; or
a different Universal Subscriber Identity Module (USIM) being inserted into the UE; or
expiry of a timer.

3. The method of claim 1, wherein the reject cause indicates that attempting a specific satellite access is not allowed, and wherein the either or both refraining to attempt the satellite access and disabling the satellite access capability of the UE comprises refraining to attempt the specific satellite access and disabling the specific satellite access by the UE for a specific public land mobile network (PLMN) for which the message was received or all PLMNs until:
the UE being switched off and back on; or
a different Universal Subscriber Identity Module (USIM) being inserted into the UE; or
expiry of a timer.

4. The method of claim 1, wherein the reject cause indicates that re-attempting a specific satellite access is not allowed for a specific public land mobile network (PLMN), and wherein the disabling of the satellite access capability of the UE comprises disabling the specific satellite access by the UE for the specific PLMN for which the message was received.

5. The method of claim 4, further comprising:
enabling, by the processor, the satellite access capability of the UE upon expiry of a related timer.

6. The method of claim 1, wherein the message comprises a reject message, a DEREGISTRATION message or a DETACH message with the reject cause, and wherein the receiving of the message comprises receiving the message upon the network determining that a UE subscription has changed while the UE is registered in the network and in an IDLE mode or a CONNECTED mode.

7. The method of claim 1, further comprising:
utilizing, by the processor, a Universal Subscriber Identity Module (USIM) responsive to the USIM being inserted into the UE,
wherein the USIM is configured with a satellite restricted subscription, and
wherein the receiving of the message with the reject cause comprises receiving the message from the network responsive to utilizing the USIM.

8. The method of claim 1, further comprising:
either or both, by the processor, allowing to access the satellite access and enabling the satellite access capability of the UE responsive to:
the UE being switched off and back on; or
a different Universal Subscriber Identity Module (USIM) being inserted into the UE; or
expiry of a timer.

9. The method of claim 1, further comprising:
starting, by the processor, a timer responsive to receiving the message with the reject cause; and
enabling, by the processor, the satellite access capability of the UE responsive to expiry of the timer,
wherein the timer is stopped responsive to either the UE being switched off and back on or a different Universal Subscriber Identity Module (USIM) being inserted into the UE.

10. A method, comprising:
determining, by a processor of a user equipment (UE), that satellite access by the UE is allowed according to a UE configuration; and
implementing, by the processor, a result of the determining,
wherein the UE configuration comprises a Universal Subscriber Identity Module (USIM) configuration or a management object (MO) configuration.

11. The method of claim 10, wherein the USIM configuration indicates one or more of:
the satellite access to a specific service being allowed or restricted;
description of allowance of the satellite access or a restriction on the satellite access; and
an Operator Controlled Public Land Mobile Network (PLMN) Selector with Access Technology list not containing the satellite access as a radio access technology (RAT) in one or more PLMNs.

12. The method of claim 10, wherein the MO configuration comprises a non-access stratum (NAS) configuration MO indicating allowance or a restriction on the satellite access in one or more public land mobile networks (PLMNs).

13. An apparatus implementable in a user equipment (UE), comprising:
a transceiver configured to communicate wirelessly with a network; and
a processor coupled to the transceiver and configured to perform operations comprising:
receiving, via the transceiver, from a satellite access cell of the network a message with a reject cause; and
either or both refraining to attempt a satellite access and disabling the satellite access capability of the UE responsive to receiving the message.

14. The apparatus of claim 13, wherein the reject cause indicates that the satellite access is not allowed, and wherein the either or both refraining to attempt the satellite access and disabling the satellite access capability of the UE comprises refraining to attempt the satellite access and disabling the satellite access capability of the UE for one or more of:
a specific access for which the message was received;
an access to all satellites; and
a specific public land mobile network (PLMN) for which the message was received or all PLMNs until:
the UE being switched off and back on; or
a different Universal Subscriber Identity Module (USIM) being inserted into the UE; or
expiry of a timer.

15. The apparatus of claim 13, wherein the reject cause indicates that attempting a specific satellite access is not allowed, and wherein the either or both refraining to attempt the satellite access and disabling the satellite access capability of the UE comprises refraining to attempt the specific satellite access and disabling the specific satellite access by the UE for a specific public land mobile network (PLMN) for which the message was received or all PLMNs until:
the UE being switched off and back on; or
a different Universal Subscriber Identity Module (USIM) being inserted into the UE; or
expiry of a timer.

16. The apparatus of claim 13, wherein the reject cause indicates that re-attempting a specific satellite access is not allowed for a specific public land mobile network (PLMN), and wherein the disabling of the satellite access capability of the UE comprises disabling the specific satellite access by the UE for the specific PLMN for which the message was received.

17. The apparatus of claim 13, wherein the message comprises a reject message, a DEREGISTRATION message or a DETACH message with the reject cause, and wherein the receiving of the message comprises receiving the message upon the network determining that a UE subscription has changed while the UE is registered in the network and in an IDLE mode or a CONNECTED mode.

18. The apparatus of claim 13, wherein the processor is further configured to perform operations comprising:
utilizing a Universal Subscriber Identity Module (USIM) responsive to the USIM being inserted into the UE,
wherein the USIM is configured with a satellite restricted subscription, and
wherein the receiving of the message with the reject cause comprises receiving the message from the network responsive to utilizing the USIM.

19. The apparatus of claim 13, wherein the processor is further configured to perform operations comprising:
either or both allowing to access the satellite access and enabling the satellite access capability of the UE responsive to:
the UE being switched off and back on; or
a different Universal Subscriber Identity Module (USIM) being inserted into the UE; or
expiry of a timer.

20. The apparatus of claim 13, wherein the processor is further configured to perform operations comprising:
starting a timer responsive to receiving the message with the reject cause; and
enabling the satellite access capability of the UE responsive to expiry of the timer,
wherein the timer is stopped responsive to either the UE being switched off and back on or a different Universal Subscriber Identity Module (USIM) being inserted into the UE.
